(19) United States
(12) Patent Application Publication
(10) Pub. No.: US 2009/0283482 A1
(43) Pub. Date: Nov. 19, 2009

(54) Kitchen Utensil

(75) Inventors: Gillian Owen, Addlestone (GB); Edward S. Sherman, Santa Rosa, CA (US)

Correspondence Address: MEYER CORPORATION, U.S.;ATTN: EDWARD S. SHERMAN, ESQ., ONE MEYER PLAZA, VALLEJO, CA, 94590, US

(73) Assignee: MEYER INTELLECTUAL PROPERTIES LIMITED, Kowloon (HK)

(21) Appl. No.: 12/466,561

(22) Filed: May 15, 2009

(30) Foreign Application Priority Data
May 16, 2008 (GB) 0909026.8

(51) Int. Cl. A47J 36/20; B01D 35/02; C02F 1/40; A47J 36/00

(52) U.S. Cl. 210/774; 210/470; 99/355; 210/776

(57) ABSTRACT

The present invention relates to a kitchen utensil 10 for separating and removing congealed fat 30 from cooked food 12 in a cooking vessel 14. The utensil comprises: a generally planar portion 16 shaped to correspond with a shape of a receptacle 18 of said cooking vessel and sized to fit within said receptacle so that an outer periphery 20 of the planar portion is contiguous with an internal periphery 22 of the receptacle; and a handle to allow a user to handle the utensil. The planar portion 16 contains perforations 24 sized so that when the utensil is rested on food in said receptacle liquid fat generated during cooking is allowed to pass from the food through said perforations and when cool congealed fat is generally prevented from passage back through said perforations. The handle allows a user to remove the utensil and congealed fat from said receptacle.

### CROSS REFERENCE TO RELATED APPLICATIONS

The present application claims priority to the UK patent application having application no. 0809026.8, which was filed on May 16, 2008, under the title “Kitchen Utensil”, which is incorporated herein by reference.

### BACKGROUND OF INVENTION

This invention relates to a kitchen utensil, cooking apparatus comprising a cooking vessel and a kitchen utensil, a method of separating fat from food in a cooking vessel, and to a packaged kitchen utensil.

It is generally desirable to move as much fat as possible from stews, soups and casseroles for health reasons.

There are numerous prior art devices constructed for use in various processes to separate the liquid fat layer that floats above the largely aqueous phase of cooked foodstuffs contained in a cooking vessel.

These device are difficult to use, and are not efficient at completely removing liquid fat.

It is therefore a first object of the present invention to provide an improved means, method and utensil for removing fat from cooked foods.

### SUMMARY OF INVENTION

According to the present invention there is provided a kitchen utensil for separating and removing congealed fat from cooked food in a cooking vessel, the utensil comprising: a generally planar portion shaped to correspond with a shape of a receptacle of said cooking vessel and sized to fit within said receptacle so that an outer periphery of the planar portion is contiguous with an internal periphery of the receptacle; and a handle to allow a user to handle the utensil; wherein the planar portion contains perforations sized so that when the utensil is rested on food in said receptacle liquid fat generated during cooking is allowed to pass from the food through said perforations and when cool congealed fat is generally prevented from passage back through said perforations; and wherein said handle allows a user to remove the utensil and congealed fat from said receptacle.

The present invention also provides cooking apparatus comprising: a cooking vessel having a receptacle for receiving food for cooking; and a kitchen utensil for separating and removing congealed fat from cooked food in the cooking vessel, the utensil comprising: a generally planar portion shaped to correspond with a shape of a receptacle of said cooking vessel and sized to fit within said receptacle so that an outer periphery of the planar portion is contiguous with an internal periphery of the receptacle; and a handle to allow a user to handle the utensil; wherein the planar portion contains perforations sized so that when the utensil is rested on food in said receptacle liquid fat generated during cooking is allowed to pass from the food through said perforations and when cool congealed fat is generally prevented from passage back through said perforations; and wherein said handle allows a user to remove the utensil and congealed fat from said receptacle.

The present invention also provides a cooking apparatus comprising: a set of differently sized cooking vessels having differently sized receptacles for receiving food for cooking; and a set of differently sized kitchen utensils adapted for separating and removing congealed fat from cooked food in respective said cooking vessels, the utensils each comprising: a generally planar portion shaped to correspond with a shape of a receptacle of one of said cooking vessels and sized to fit within said receptacle so that an outer periphery of the planar portion is contiguous with an internal periphery of the receptacle; and a handle to allow a user to handle the utensil; wherein the planar portion contains perforations sized so that when the utensil is rested on food in said receptacle liquid fat generated during cooking is allowed to pass from the food through said perforations and when cool congealed fat is generally prevented from passage back through said perforations; and wherein said handle allows a user to remove the utensil and congealed fat from said receptacle.

The present invention also provides a method of separating and removing congealed fat from cooked food in a cooking vessel, the method comprising the steps of: heating food in the cooking vessel; resting a kitchen utensil comprising a generally planar portion on the food, said planar portion having perforations and being shaped to correspond with a shape of a receptacle of said cooking vessel and sized to fit within said receptacle so that an outer periphery of the planar portion is contiguous with an internal periphery of the receptacle, wherein said perforations are sized so that when the utensil is rested on the food in said receptacle liquid fat generated during cooking passes from the food through said perforations; allowing said cooking vessel to cool so that congealed fat is generally prevented from passage back through said perforations; and lifting the utensil away from the cooking vessel using a handle of the utensil.

The present invention also provides a packaged kitchen utensil for separating and removing congealed fat from cooked food in a cooking vessel, the utensil comprising:a generally planar portion shaped to correspond with a shape of a receptacle of said cooking vessel and sized to fit within said receptacle so that an outer periphery of the planar portion is contiguous with an internal periphery of the receptacle; a handle to allow a user to handle the utensil; wherein the planar portion contains perforations sized so that when the utensil is rested on food in said receptacle liquid fat generated during cooking is allowed to pass from the food through said perforations and when cool congealed fat is generally prevented from passage back through said perforations; wherein said handle allows a user to remove the utensil and congealed fat from said receptacle; and wherein the packaged kitchen utensil comprises packaging on which are displayed instructions according to the method as described above.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a perspective view of a kitchen utensil;

FIG. 2A is a cross-sectional elevation view of a cooking apparatus comprising a cooking vessel and the kitchen utensil shown in FIG. 1, whereas FIG. 2B is an enlarged view of a portion of the utensil in FIG. 2A;

FIG. 3 is a plan view of FIG. 2A;

FIG. 4 to 7 show various stages of the kitchen utensil in use;

FIG. 8 shows an alternative embodiment of the kitchen utensil in plan view;

FIG. 9 shows another alternative embodiment of the kitchen utensil in an elevation view;

FIG. 10A is a perspective view of another alternative embodiment of the kitchen utensil in an upright position, whereas FIG. 10B shows the same utensil in an inverted position.

FIG. 11A is a plan view of the kitchen utensil of FIG. 10; FIG. 11B is a first elevation thereof, and FIG. 11C is an elevation thereof orthogonal to the elevation shown in FIG. 11B;

FIG. 12A illustrates a first mode of using the kitchen utensil of FIG. 10 and 11, whereas FIG. 12B illustrates a second mode of using the kitchen utensil of FIG. 10 and 11; and

FIG. 13 is a perspective view of another embodiment of the kitchen utensil.

### DETAILED DESCRIPTION

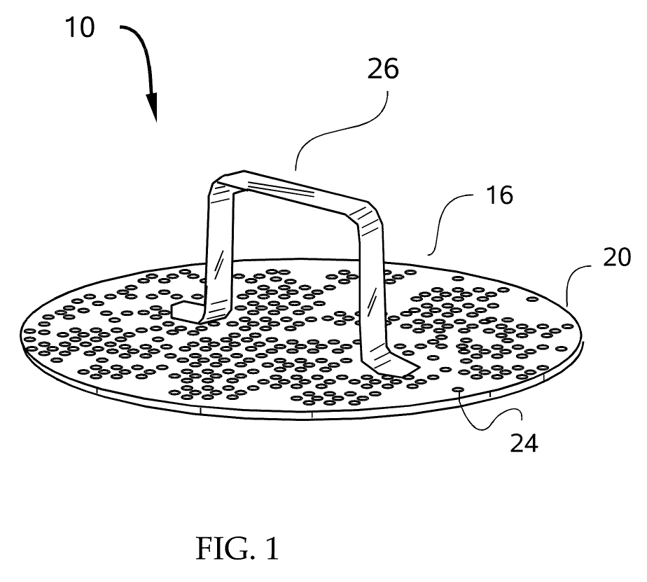

Referring to FIGS. 1 through 13, wherein like reference numerals refer to like components in the various views, there is illustrated therein a new and improved kitchen utensil, generally denominated 10 herein.

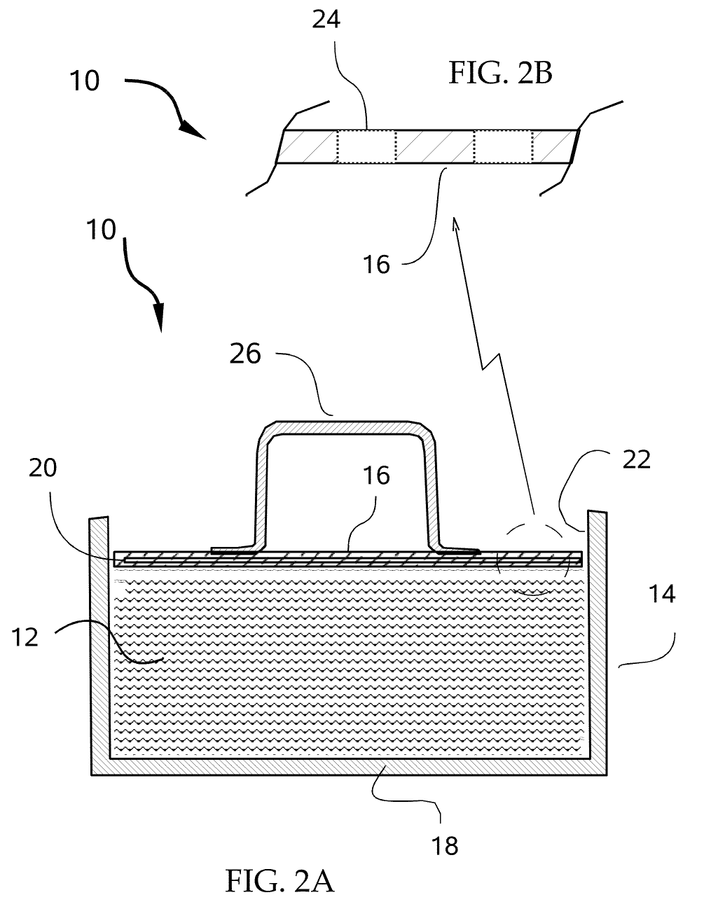

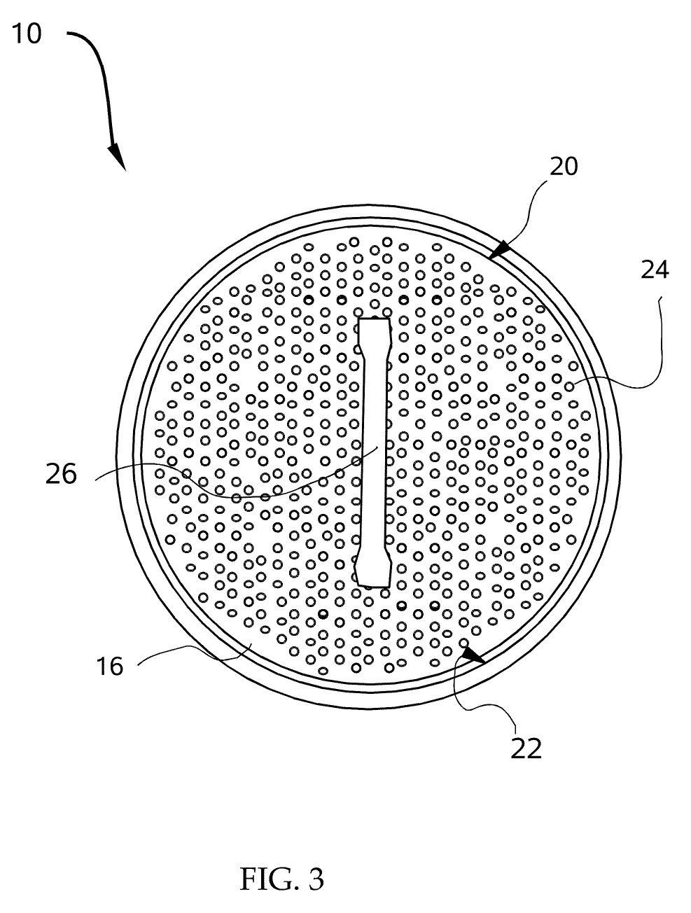

Referring to FIGS. 1 to 3, a kitchen utensil 10 is shown for separating and removing congealed fat from cooked food 12 in a cooking vessel 14. The utensil 10 comprises a generally planar portion 16 which is dimensioned so that it is suitable for a cooking vessel. Accordingly, the planar portion is shaped to correspond with a shape of a receptacle 18 of the cooking vessel 14. In the example shown in FIGS. 1 to 3, the receptacle of the cooking vessel is generally circular and the planar portion is also circular (a disc as shown) to correspond with the shape of the cooking vessel 14. The planar portion 16 is sized to fit within the receptacle 18 so that an outer periphery 20 of the planar portion 16 is contiguous with an internal periphery 22 of the receptacle 18. Accordingly, when the utensil 10 is rested on food 12 in the receptacle of the cooking vessel 14 as shown in FIGS. 2 and 3, the planar portion 16 is generally parallel to a base of the cooking vessel and the outer periphery 20 of the planar portion 16 is closely adjacent to the inner periphery 22 of the receptacle 18 to prevent significant amounts of food from passing between the outer periphery of the planar portion and the inner periphery of the receptacle. The arrangement also ensures that most, if not all, of the congealed fat in the cooking vessel can be removed when the utensil is removed from the cooking vessel. For example, if a 20 cm diameter planar portion, or disc, were used in a 24 cm casserole pan there would be a 2 cm gap round the edge, between an outer periphery of the planar portion and an inner periphery of the receptacle, and some of the smaller food contents in the cooking vessel may possibly ‘come over the top’ and compromise the filtered fat.

Cooking vessels, such as saucepans and casserole dishes, are typically distributed in standard diameters, usually increasing by 2 cm from one cooking vessel to the next cooking vessel in a set of cooking vessels. For instance, a standard set of three saucepans, may measure 16 cm, 18 cm and 20 cm, and for larger casseroles and frying pans the receptacles may measure 24 cm and 26 cm.

Cooking apparatus may be marketed and sold comprising a cooking vessel having a receptacle for receiving food for cooking and a kitchen utensil for separating and removing congealed fat from cooked food in the cooking vessel.

Additionally, the kitchen utensil 10 may be marketed and sold as part of cooking apparatus comprising a set of differently sized cooking vessels 14 having differently sized receptacles for receiving food for cooking; and a set of differently sized kitchen utensils 10 adapted for separating and removing congealed fat from cooked food in respective cooking vessels 14. For example, the cooking apparatus may comprise three saucepans measuring 16 cm, 18 cm and 20 cm, and utensils 10 having planar portions 16 measuring 15 cm, 17 cm and 19 cm.

The planar portion 16 contains perforations 24 sized so that when the utensil is rested on food 12 in the receptacle 18 liquid fat generated during cooking is allowed to pass from the food through the perforations 24 and when cool congealed fat is generally prevented from passage back through the perforations. The number of perforations is selected so that even distribution of perforations in the planar portion is achieved and so that liquid fat throughout the cooking vessel can readily pass through one of the perforations.

Generally, the kitchen utensil removes fat most efficiently when the fat is solid at ambient temperatures and liquid at typical cooking temperatures. The fat may be present for instance in meat prior to cooking.

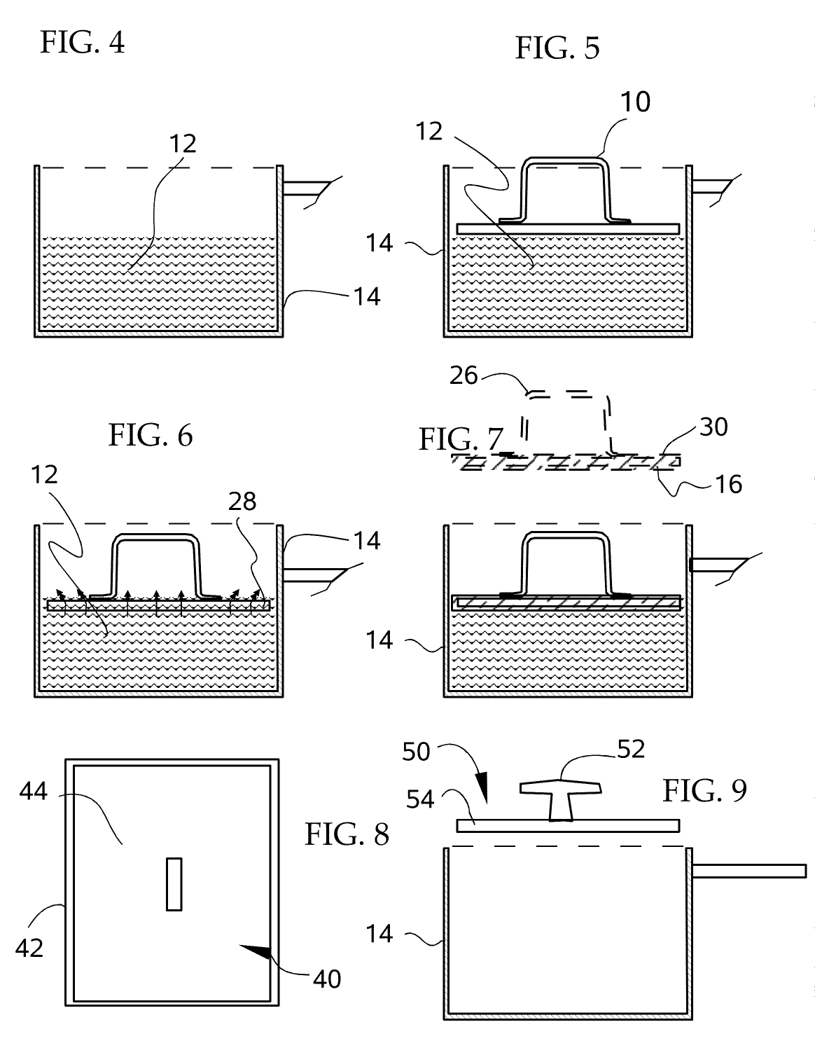

A suitable diameter of the perforations is 4 mm which allows the fat to pass through the perforations, whilst preventing smaller cuts of meat (e.g. mince) or vegetables to pass through. Such a diameter is also sufficiently small to reduce the tendency of softer consistency solidified fat falling back through some of the perforations when the disc, or planar portion, 16 is lifted. Using significantly smaller diameter perforations, such as less than about 1 mm means that it is more difficult for the liquid fat to filter through the perforations, especially if it is of a thicker consistency. Further, small food particle can easily stick to and hence clog small perforation. Further as small perforations would tend to provide higher surface area, surface tension would tend to cause the kitchen utensil to flood on the surface of the fat, when it is desirable to descend at least into or slightly below floating liquid fat, as shown in FIG. 4-7. Hence, as a preferred means of using the utensil 10 is to chill the cooked food stuff with the kitchen utensil partly submerged, it is desirable that the utensil not float, but stay at the fluid-fat interface while the pot and utensil are chilled in a refrigerator.

For the above, and other reasons it should now be appreciate that the planar portion is preferably fabricated from a metallic plate, and may be stamped, laser cut or cast. An underside of the planar portion is preferably coated with a non-stick coating, but such coating are more preferably applied to the upper side and all exposed surface. Metal, or metal alloy, is a suitable material because it is possible for the planar portion to be relatively thin whilst retaining sufficient strength and rigidity to allow the utensil to be lifted from the cooking vessel and retain the congealed fat on an upper surface without significant bending. It is advantageous that the planar portion does not bend significantly since bending can cause congealed fat to break away and fall off the planar portion when lifted. 1.2 mm gauge catering grade, mirror polished, stainless steel may be used and a disc measuring 235 mm in diameter has in the region of 600 perforations.

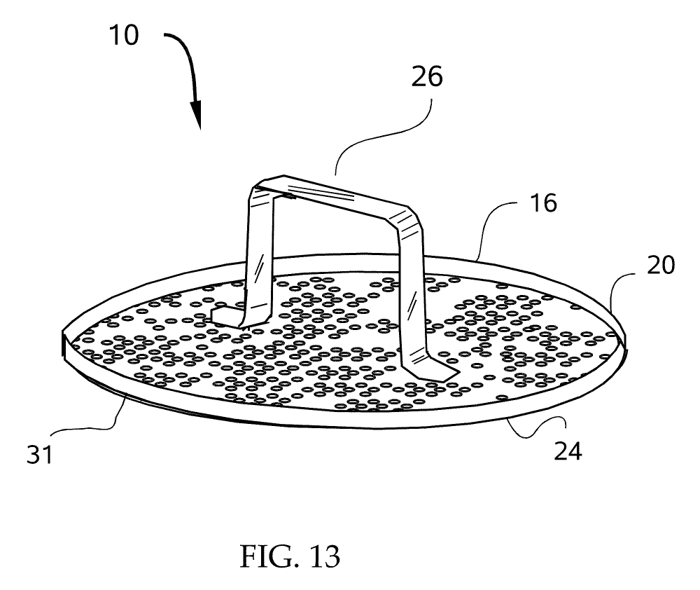

Alternatively, while the planar portion may be a mesh, net or sieve, this is less preferred for several reasons. Unless the wires or filaments forming the mesh are appreciably stiff, such as being relatively large diameter steel wire, and/or relatively closely spaced it is difficult to provide sufficient stiffness for the device to perform an intended function of removing substantially all the congealed fat in a single piece, as flexing would tend to cause fat to crack a fall off. It will of course be appreciated that the flimsiest mesh or net can be rendered stiff when stretched over a supporting frame or ring. However, this is less desirable for the above reasons, as well as that the ring or frame would need to be placed just under the fat to fully removed it when congealed. The planar device, with multiple holes in contrast is efficient at removing fat irrespective of it being placed just below or in the within the floating liquid fat layer prior to its congealing. Further, a mesh, net or sieve will tend to have small interstices that trap food particle and require more effort to clean to a sanitary condition. The planar portion may comprise a raised lip or flange 31, as shown in FIG. 13, at the outer periphery thereof for containing congealed fat on an upper surface.

A handle 26 allows a user to handle the utensil and remove the utensil 10 and congealed fat from the receptacle without touching the planar portion or congealed fat. In this example, the handle is 90 mm long. Handle length could be longer and not interfere with functionality. However, the height of the handle from the disc is 60 mm as there needs to be enough space for clearance between a user's hand and the solidified fat when the user removes the utensil from the cooking vessel. The handle is not restricted to these dimensions since for instance a handle of less height may be used but it would be less convenient for a user to lift the utensil. The handle may be spot welded to the planar portion.

A method of separating fat from food in a cooking vessel will now be described with reference to FIGS. 4 to 7.

As shown in FIG. 4, food 12 is placed in the receptacle of a cooking vessel 14. The type of food from which fat can most readily be separated are generally fluid or semi-fluid, such as bolognese or chilli-con-carne sources. In such sources, liquid fat is relatively mobile and tends to rise to a surface of the source. Heat is applied to the cooking vessel. Solid fat contained in meat or other food constituents tends to liquefy on heating and typically rise to the surface of the food as it is less dense than water. However, during cooking the food may be stirred regularly, if stirring is required, in which case the liquid fat tends to be distributed relatively evenly throughout the food.

When cooking is complete the cooking vessel and food is left to rest, and the utensil 10 is rested on top of the food as shown in FIG. 5. The planar portion 16 may submerge or partially submerge in the cooking juices/gravy. The planar portion may be rested on the food prior to finishing cooking and cooking completed with the utensil in place.

The perforations 24 in the planar portion 16 allow liquid fat 28 generated during cooking to rise in the food (represented by arrows in FIG. 6) and pass from the food through the perforations.

When cool the congealed fat forms a layer 30 which covers the planar portion 16. The handle 26 extends away (generally upwardly) from the planar portion and through the layer 30 so that, as shown in FIG. 7, a user can grip the handle and remove the utensil, with the layer of fat, from the receptacle.

The perforations are sized so that the congealed fat does not tend to pass through the perforations and therefore the planar portion 16 acts as a filter or barrier allowing passage of fat in one direction but substantially resisting passage in an opposing direction.

There is an element of suction involved when the fat has solidified and sealed round the outer periphery 20 of the planar portion 16, which requires a decent strength of stainless steel to stop any bending/flexing etc. on removal. A thinner gauge steel may be acceptable if there is only a small layer of fat to remove.

Accordingly, fat is separated and can solidify on top of the cooked contents. The utensil 10 in use is usually able to remove at least the weight of fat stated on a packet of meat used in the food. Whereas, when carefully trying to remove solidified fat from a dish without using the utensil 10 (i.e. mingled in with contents), apart from taking much longer, only 50-60% of the stated fat content can successfully be removed.

It should be apparent from the foregoing discussion that although any size method or sieve could theoretically be used in place of planar portion 16, it is most preferred that the planar portion be relatively stiff, like a rigid plate, so as to not deform and break off congealed fat when removed form the vessel or casserole pan. However, unlike prior art devices for removing liquid fat, it is also preferred that the perforation be relatively uniform in size and density in the entire expanse of the planar portion 16 in order to most efficiently capture and remove the greatest portion of congealed fat.

Uniform density means any portion of the planar surface selected for examination having 2 or more perforation will have about the same number of equal sized perforations as any other portion of the same dimensions that can be found elsewhere on the planar surface. More preferably, while the perforations may vary somewhat in shape from round, they should be spaced a generally equal distance apart as the perforation diameter, such that the projected area of all the perforations should not in total exceed more than about 50% of the area of the planar portion as this would weaken the metal disk, causing it to flex like or screen or mesh from the suction when the user pulls on the handle 26.

A packaged kitchen utensil may comprise packaging on which are displayed instructions according to the method described generally with reference to FIGS. 4 to 7.

FIG. 8 shows a further kitchen utensil 40 and cooking vessel 42. The cooking vessel 42 is rectangular and the kitchen utensil 40 has a planar portion 44 which is also rectangular to correspond with the shape of the cooking vessel. Such rectangular cooking vessels are often used for industrial, restaurant or school cooking. The perforations are not shown in FIG. 8.

FIG. 9 shows a still further kitchen utensil 50 in which a handle 52 comprises a knob and connection piece welded to the planar portion 54.

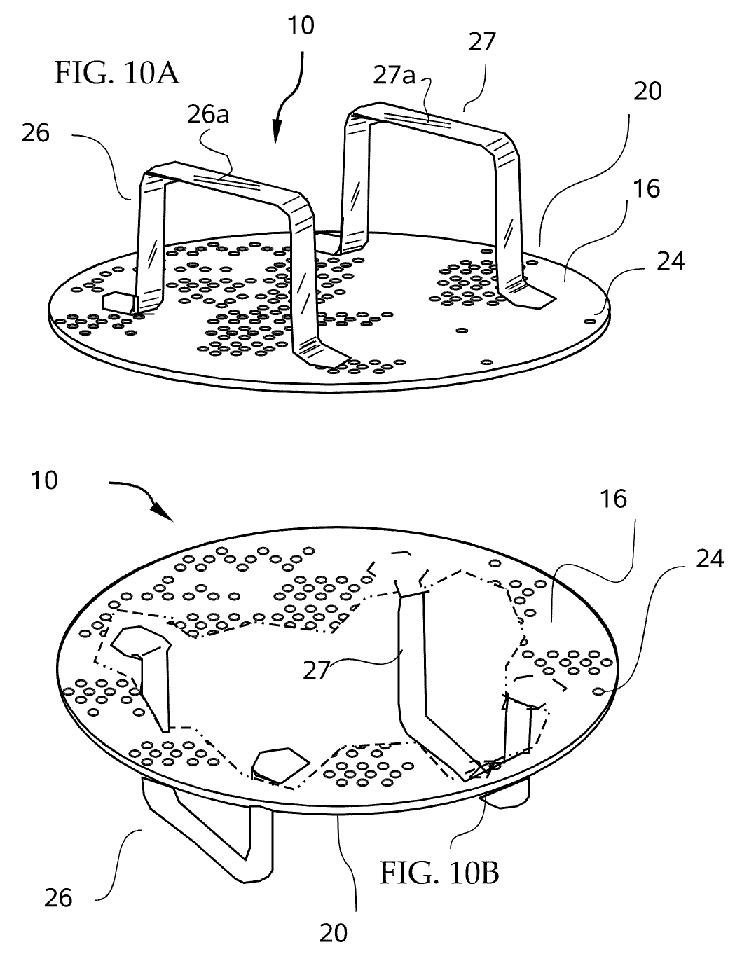

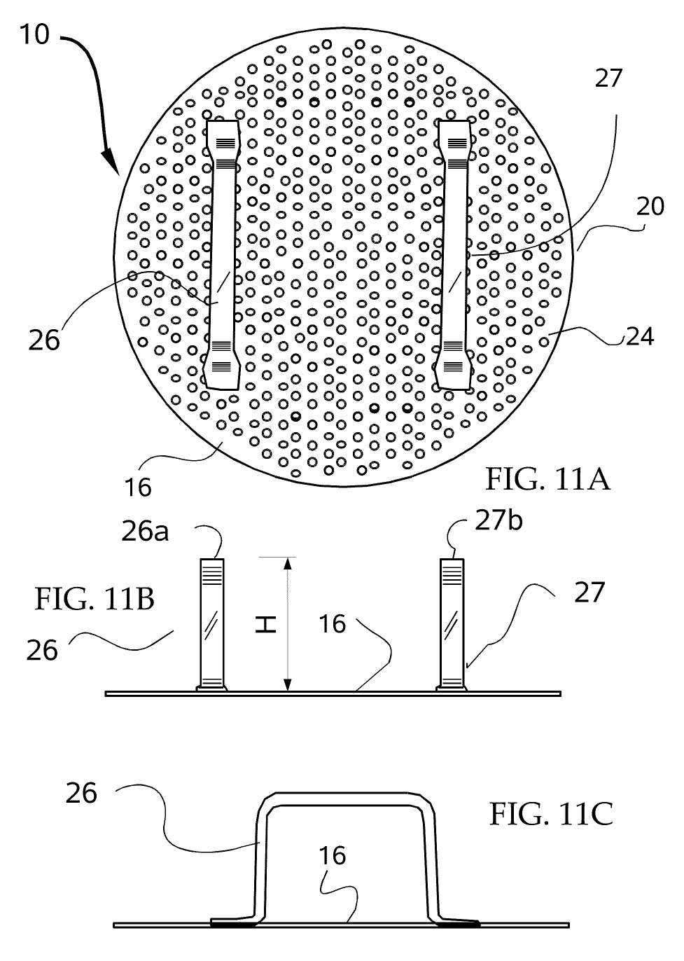

FIG. 10-11 show another kitchen utensil 10 for separating and removing congealed fat from cooked food 12 in a cooking vessel 14. Like the other embodiments, the utensil 10 comprises a generally planar portion 16 which is dimensioned so that it is suitable for a cooking vessel. However, this embodiment comprise a pair of handles 26 and 27 that each have a planar central portion 26a and 27a respectively that are co-planar with each other and spaced apart to define a plane perpendicular with the planar portion 16 by a distance H, as shown in FIG. 11B.

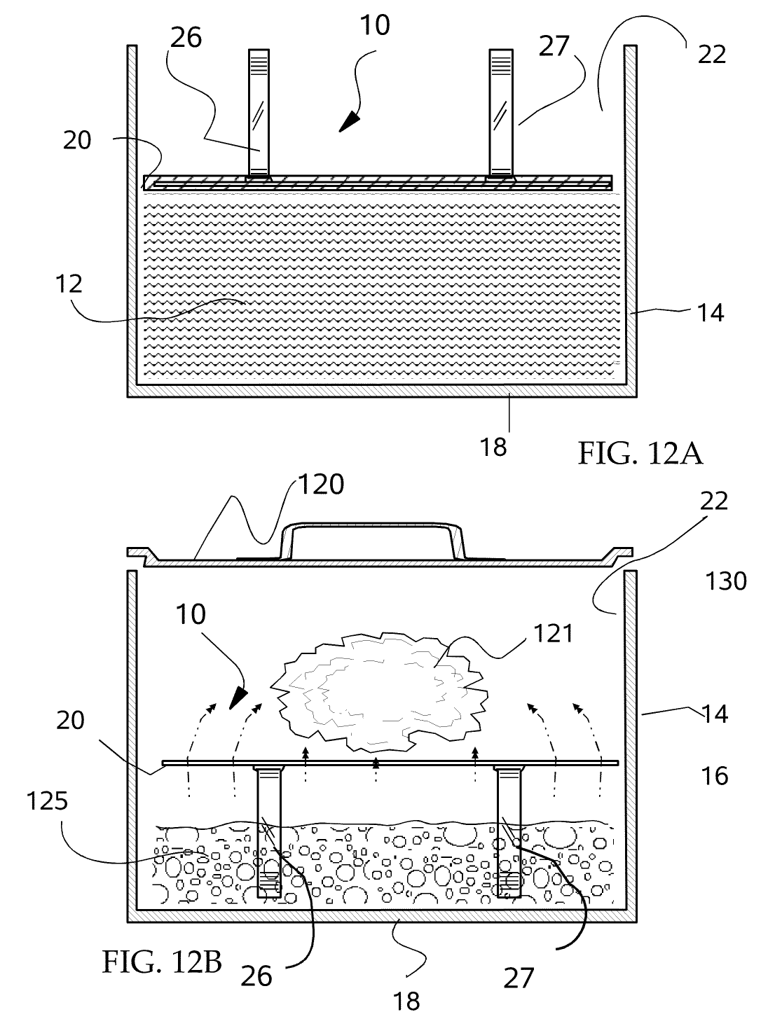

FIG. 12 illustrates that utensil 10 is capable of use in the same manner as the other embodiments. However it is also capable of use in an inverted fashion in vessel 14 as shown in FIG. 12B, in which the vessel containers boiling water 125 and planar portion 16 is now supported there above on handles 26 and 27, which rest on the bottom 18 of vessel 17. The foodstuff 121 is now being cooked with steam that passes through perforation 24, the flow of which is now schematically illustrated by the use of curved arrows of broken lines with double heads. Vessel 17 is covered by lid 120 that extends to vessel rim 130 to retain this steam.

It should be apparent that the handles 26 and 27 being spaced between the center of the portion 16 and the edge thereof, provide a stable support for utensil 10 when inverted as in FIG. 12B. It should be appreciated that it is not essential to have 2 handles to accomplish this result, so long as the 1 or more handles have at least a series of one or more upper planar portion disposed between outer periphery 20 of portion 16 and inward there from by up to about ¼ to ⅓ the diameter of portion 16. More preferably the one or more handles together provide 2 or more such planar portions for support. The extent and location of these planar portions of at least one handle can be varied to form a stable support base when utensil 10 is inverted. It is preferable that the planar portions are inset somewhat from the outer periphery 20, so that a slight tilting of the planar portion when inverted provides access to this edge for gripping an removal from the pan.

The invention has been described by way of several embodiments with modifications and alternatives, but having read and understood this description, further embodiments and modifications will be apparent to those skilled in the art. All such embodiments and modifications are intended to fall within the scope of the present invention as defined in the accompanying claims. Accordingly, the aspects and features discussed with one embodiment or a preferred embodiment, may be combined with those of other embodiments, and are not intended to limit the scope of the invention to the particular form set forth, but on the contrary, it is intended to cover such alternatives, modifications, and equivalents as may be within the spirit and scope of the invention as defined by the appended claims.

We claim:

1. A method of separating and removing congealed fat from cooked food in a cooking vessel, the method comprising the steps of:
a) heating food in the cooking vessel;
b) resting a kitchen utensil comprising a generally planar portion on the food, said planar portion having perforations and being shaped to correspond with a shape of a receptacle of said cooking vessel and sized to fit within said receptacle so that an outer periphery of the planar portion is contiguous with an internal periphery of the receptacle, wherein said perforations are sized so that when the utensil is rested on the food in said receptacle liquid fat generated during cooking passes from the food through said perforations;
c) allowing said cooking vessel to cool so that congealed fat is generally prevented from passage back through said perforations; and
d) lifting the utensil away from the cooking vessel using a handle of the utensil.

2. A method of separating and removing congealed fat from cooked food in a cooking vessel according to claim 1 wherein the generally planar portion is a plate having plurality of uniform perforations dispersed in substantially uniform density over the lateral surface thereof.

3. A method of separating and removing congealed fat from cooked food in a cooking vessel according to claim 1 wherein the generally planar portion is selected from the group consisting or a mesh, net and sieve.

4. A method of separating and removing congealed fat from cooked food in a cooking vessel according to claim 1 wherein the perforations comprises less that about 50% of the projected area of the planar portion thereof.

5. A method of separating and removing congealed fat from cooked food in a cooking vessel according to claim 1 wherein when cooled the congealed fat forms a layer which covers the planar portion and wherein the handle extends away from said planar portion so that a user can grip the handle and the remove the utensil with the layer of fat from the receptacle.

6. A method of separating and removing congealed fat from cooked food in a cooking vessel according to claim 1 wherein the utensil comprises a first and second handle each having an upper planar portion that extends parallel to said planar portion having perforation for stably supporting the utensil on the interior cooking surface of a pot when inverted such that the handles extend downward from the planar portion.

7. A kitchen utensil for separating and removing congealed fat from cooked food in a cooking vessel, the utensil comprising:
a) a generally planar portion shaped to correspond with a shape of a receptacle of said cooking vessel and sized to fit within said receptacle so that an outer periphery of the planar portion is contiguous with an internal periphery of the receptacle; and
b) at least one handle coupled to the planar portion allow a user to handle the utensil;
c) wherein the planar portion contains perforations sized so that when the utensil is rested on food in said receptacle liquid fat generated during cooking is allowed to pass from the food through said perforations and when cool congealed fat is generally prevented from passage back through said perforations; and
d) wherein said handle allows a user to remove the utensil with substantially of the congealed fat from said receptacle.

8. A kitchen utensil according to claim 7 wherein the at least one handle is connected directly to the planar portion allow a user to handle the utensil;

9. A kitchen utensil according to claim 7 wherein the generally planar portion is a plate having plurality of uniform perforations dispersed in substantially uniform density over the lateral surface thereof.

10. A kitchen utensil according to claim 7 wherein the generally planar portion is selected from the group consisting or a mesh, net and sieve.

11. A kitchen utensil according to claim 7 wherein the perforations comprises less that about 50% of the projected area of the planar portion thereof.

12. A kitchen utensil according to claim 7 wherein when cool the planar portion forms a barrier separating the food from the congealed fat.

13. A kitchen utensil according to claim 7 wherein, when the utensil is rested on food in the receptacle of the cooking vessel, the planar portion is generally parallel to a base of the cooking vessel and said outer periphery of said planar portion is closely adjacent to the inner periphery of the receptacle to prevent significant amounts of food from passing between the outer periphery of the planar portion and inner periphery of the receptacle.

14. A kitchen utensil according to claim 7 wherein the planar portion is fabricated from a metallic plate.

15. A kitchen utensil according to claim 7 comprising a first and second handle, the first and second handle each having an upper planar portion that extends parallel to said planar portion having perforation for stably supporting the utensil on the interior cooking surface of a pot when inverted such that the handles extend downward from the planar portion.

16. A kitchen utensil according to claim 7 wherein the at least one handle that provides a series of one or more upper planar portion that extends parallel to said planar portion having perforation for stably supporting the utensil on the interior cooking surface of a pot when inverted.

17. A kitchen utensil according to claim 16 wherein the at least one handle provides a series of two or more upper planar portions disposed between the outer periphery of inward there from by up to about ¼ to ⅓ the diameter of planar portion having perforations.

18. A cooking apparatus comprising:
a) a cooking vessel having a receptacle for receiving food for cooking; and
b) a kitchen utensil for separating and removing congealed fat from cooked food in the cooking vessel, the utensil comprising:
c) a generally planar portion shaped to correspond with a shape of a receptacle of said cooking vessel and sized to fit within said receptacle so that an outer periphery of the planar portion is contiguous with an internal periphery of the receptacle; and
d) a handle to allow a user to handle the utensil;
e) wherein the planar portion contains perforations sized so that when the utensil is rested on food in said receptacle liquid fat generated during cooking is allowed to pass from the food through said perforations and when cool congealed fat is generally prevented from passage back through said perforations; and
f) wherein said handle allows a user to remove the utensil and congealed fat from said receptacle.

19. A cooking apparatus comprising:
a) a set of differently sized cooking vessels having differently sized receptacles for receiving food for cooking; and
b) a set of differently sized kitchen utensils adapted for separating and removing congealed fat from cooked food in respective said cooking vessels, the utensils each comprising:
c) a generally planar portion shaped to correspond with a shape of a receptacle of one of said cooking vessels and sized to fit within said receptacle so that an outer periphery of the planar portion is contiguous with an internal periphery of the receptacle; and
d) a handle to allow a user to handle the utensil;
e) wherein the planar portion contains perforations sized so that when the utensil is rested on food in said receptacle liquid fat generated during cooking is allowed to pass from the food through said perforations and when cool congealed fat is generally prevented from passage back through said perforations; and

20. A packaged kitchen utensil for separating and removing congealed fat from cooked food in a cooking vessel, the utensil comprising:
a) a generally planar portion shaped to correspond with a shape of a receptacle of said cooking vessel and sized to fit within said receptacle so that an outer periphery of the planar portion is contiguous with an internal periphery of the receptacle;
b) a handle to allow a user to handle the utensil;
c) wherein the planar portion contains perforations sized so that when the utensil is rested on food in said receptacle liquid fat generated during cooking is allowed to pass from the food through said perforations and when cool congealed fat is generally prevented from passage back through said perforations;
d) wherein said handle allows a user to remove the utensil and congealed fat from said receptacle.
